(19) United States
(12) Patent Application Publication
(10) Pub. No.: US 2024/0174548 A1
(43) Pub. Date: May 30, 2024

(54) GLASS MATERIAL

(71) Applicant: CDGM GLASS CO., LTD, Chengdu (CN)

(72) Inventors: Lulu MAO, Chengdu (CN); Bo KUANG, Chengdu (CN); Liangzhen HAO, Chengdu (CN)

(73) Assignee: CDGM GLASS CO., LTD, Chengdu (CN)

(21) Appl. No.: 18/384,929

(22) Filed: Oct. 30, 2023

(30) Foreign Application Priority Data
Nov. 30, 2022 (CN) 202211518910X

(51) Int. Cl. C03C 3/087; C03C 3/091; C03C 3/093; C03C 3/095; C03C 3/097

(52) U.S. Cl. CPC C03C 3/087; C03C 3/091; C03C 3/093; C03C 3/095; C03C 3/097

(57) ABSTRACT

The present invention provides a glass material that has a suitable thermal expansion coefficient to meet the application in the field of semiconductor manufacturing. A glass material, wherein components thereof are represented by weight percentage, comprising: 43-63% of SiO₂; 0-15% of B₂O₃; 2-15% of Al₂O₃; 11-30% of BaO; 3-18% of CaO. Through rational component design, the glass material of the present invention has a suitable thermal expansion coefficient and is applicable to the field of semiconductor manufacturing.

### TECHNICAL FIELD

The present invention relates to a glass material, in particular to a glass material applicable for the field of semiconductor manufacturing.

### BACKGROUND

In the prior art, materials with good mechanical strength and acid and alkali corrosion resistance, such as metal, ceramic, and monocrystalline silicon, are usually used as substrate for wafer in the manufacturing process, in order to prevent the deformation of wafer during photoetching, cleaning, packaging, etc.

However, since the substrate materials such as metal, ceramic, and monocrystalline silicon, are opaque, a hot stripping process is required in the substrate and wafer stripping process. If a non-opaque glass material is used as a manufacturing substrate, a photostripping process can be used. Compared with the hot stripping process, the photostripping process can significantly reduce the process time and stripping cost, and meanwhile avoid the baking of chip wafer at high temperature and improve the yield of the chip manufacturing process. On the other hand, the substrate material is generally combined with resin material, which requires the matching between thermal expansion coefficient of the substrate material and the resin material, otherwise the wafer will warp and deform when high and low temperature change is experienced in the chip manufacturing process, resulting in chip scrap.

Based on the above reasons, the development of a glass material with suitable thermal expansion coefficient is of great significance to the development of semiconductor manufacturing field.

### SUMMARY

The technical problem to be solved by the present invention is to provide a glass material that has a suitable thermal expansion coefficient to meet the application in the field of semiconductor manufacturing.

To solve the technical problem, the present invention provides the technical solution as below:

A glass material, wherein components thereof are represented by weight percentage, comprising: 43-63% of SiO₂; 0-15% of B₂O₃; 2-15% of Al₂O₃; 11-30% of BaO; 3-18% of CaO.

Furthermore, the glass material, wherein components thereof are represented by weight percentage, further comprising: 0-12% of SrO; and/or 0-8% of ZrO₂; and/or 0-10% of MgO; and/or 0-8% of Rn₂O; and/or 0-8% of Ln₂O₃; and/or 0-8% of ZnO; and/or 0-5% of TiO₂; and/or 0-5% of P₂O₅; and/or 0-2% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, SnO₂, and CeO₂.

The glass material, wherein components thereof are represented by weight percentage, consisting of: 43-63% of SiO₂; 0-15% of B₂O₃; 2-15% of Al₂O₃; 11-30% of BaO; 3-18% of CaO; 0-12% of SrO; 0-8% of ZrO₂; 0-10% of MgO; 0-8% of Rn₂O; 0-8% of Ln₂O₃; 0-8% of ZnO; 0-5% of TiO₂; 0-5% of P₂O₅; 0-2% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, SnO₂, and CeO₂.

Furthermore, the glass material, wherein components thereof are represented by weight percentage, in which: SiO₂ is 46-60%, SiO₂ is preferably 49-56%; and/or B₂O₃ is 0.5-10%, B₂O₃ is preferably 1-7%; and/or Al₂O₃ is 4-13%, Al₂O₃ is preferably 6-11%; and/or BaO is 15-25%, BaO is preferably 17-23%; and/or CaO is 5-15%, CaO is preferably 7-12%; and/or SrO is 0.5-10%, SrO is preferably 1-7%; and/or ZrO₂ is 0-5%, ZrO₂ is preferably 0-2%; and/or MgO is 0-5%, MgO is preferably 0-2%; and/or Rn₂O is 0-5%, Rn₂O is preferably 0-1%; and/or Ln₂O₃ is 0-5%, Ln₂O₃ is preferably 0-2%; and/or ZnO is 0-5%, ZnO is preferably 0-2%; and/or TiO₂ is 0-3%, TiO₂ is preferably 0-1%; and/or P₂O₅ is 0-3%, P₂O₅ is preferably 0-1%; and/or clarifying agent is 0-1%, clarifying agent is preferably 0-0.8%, the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, SnO₂, and CeO₂.

Furthermore, the glass material, wherein components thereof are represented by weight percentage, in which: RO is 16-60%, RO is preferably 20-50%, RO is more preferably 25-45%, RO is further preferably 28-40%, and the RO is a total content of MgO, CaO, SrO, and BaO.

Furthermore, the glass material, wherein components thereof are represented by weight percentage, in which: (Al₂O₃+CaO)/SiO₂ is 0.1-0.65, (Al₂O₃+CaO)/SiO₂ is preferably 0.15-0.55, (Al₂O₃+CaO)/SiO₂ is more preferably 0.2-0.5, and (Al₂O₃+CaO)/SiO₂ is further preferably 0.25-0.45.

Furthermore, the glass material, wherein components thereof are represented by weight percentage, in which: SiO₂/(BaO+CaO) is 1.0-4.0, SiO₂/(BaO+CaO) is preferably 1.2-3.0, SiO₂/(BaO+CaO) is more preferably 1.3-2.5, and SiO₂/(BaO+CaO) is further preferably 1.5-2.0.

Furthermore, the glass material, wherein components thereof are represented by weight percentage, in which: (BaO+SrO)/SiO₂ is 0.2-0.8, (BaO+SrO)/SiO₂ is preferably 0.25-0.7, (BaO+SrO)/SiO₂ is more preferably 0.3-0.65, and (BaO+SrO)/SiO₂ is further preferably 0.35-0.6.

Furthermore, the glass material, wherein components thereof are represented by weight percentage, in which: BaO/Al₂O₃ is 1.0-10.0, BaO/Al₂O₃ is preferably 1.2-8.0, BaO/Al₂O₃ is more preferably 1.5-5.0, and BaO/Al₂O₃ is further preferably 1.8-3.0.

Furthermore, the glass material, wherein components thereof are represented by weight percentage, in which: Rn₂O/BaO is below 0.6, Rn₂O/BaO is preferably below 0.5, Rn₂O/BaO is more preferably below 0.3, Rn₂O/BaO is further preferably below 0.1, and the Rn₂O is one or more of Li₂O, Na₂O, and K₂O.

Furthermore, the glass material, wherein components thereof are represented by weight percentage, in which: (Ln₂O₃+CaO)/BaO is 0.15-1.5, (Ln₂O₃+CaO)/BaO is preferably 0.2-1.0, (Ln₂O₃+CaO)/BaO is more preferably 0.25-0.8, (Ln₂O₃+CaO)/BaO is further preferably 0.3-0.7, and Ln₂O₃ is one or more of La₂O₃, Gd₂O₃, Y₂O₃, and Yb₂O₃.

Furthermore, the glass material, wherein components thereof are represented by weight percentage, in which: SrO/BaO is 0.02-0.8, SrO/BaO is preferably 0.05-0.6, SrO/BaO is more preferably 0.1-0.5, and SrO/BaO is further preferably 0.1-0.4.

Furthermore, the glass material, wherein components thereof are represented by weight percentage, in which: (ZnO+TiO₂)/SrO is below 2.0, (ZnO+TiO₂)/SrO is preferably below 1.5, (ZnO+TiO₂)/SrO is more preferably below 1.0, and (ZnO+TiO₂)/SrO is further preferably below 0.5.

Furthermore, the glass material, wherein components thereof are represented by weight percentage, in which: (SiO₂+Al₂O₃)/(BaO+B₂O₃) is 1.2-5.0, (SiO₂+Al₂O₃)/(BaO+B₂O₃) is preferably 1.5-4.0, (SiO₂+Al₂O₃)/(BaO+B₂O₃) is more preferably 1.7-3.5, and (SiO₂+Al₂O₃)/(BaO+B₂O₃) is further preferably 2.0-3.0.

Furthermore, the glass material, wherein components thereof do not contain MgO; and/or do not contain ZnO; and/or do not contain P₂O₅; and/or do not contain TiO₂; and/or do not contain Rn₂O; and/or do not contain Ln₂O₃, the Rn₂O is one or more of Li₂O, Na₂O, and K₂O, and Ln₂O₃ is one or more of La₂O₃, Gd₂O₃, Y₂O₃, and Yb₂O₃.

Furthermore, thermal expansion coefficient α_{20-300° C.} of the glass material is 50×10⁻⁷/K-68×10⁻⁷/K, preferably 51×10⁻⁷/K-65×10⁻⁷/K, more preferably 52×10⁻⁷/K-64×10⁻⁷/K; and/or transition temperature T_{g} is 620° C.-760° C., preferably 650° C.-750° C., more preferably 680° C.-740° C.; and/or Young's modulus E is above 6500×10⁷ Pa, preferably above 7000×10⁷ Pa, more preferably above 7500×10⁷ Pa; and/or acid resistance stability D_{A} is above Class 2, preferably Class 1; and/or water resistance stability D_{W} is above Class 2, preferably Class 1; and/or bubble degree is above Grade A, preferably above Grade A₀, more preferably Grade A₀₀; and/or stripe degree is above Grade C, preferably above Grade B.

Furthermore, viscosity of the glass material at 1450° C. is below 250 dPaS, the viscosity at 1450° C. is preferably below 220 dPaS, and the viscosity at 1450° C. is more preferably below 200 dPaS; and/or the viscosity at 1300° C. is above 400 dPaS, the viscosity at 1300° C. is preferably above 500 dPaS, and the viscosity at 1300° C. is more preferably above 600 dPaS; and/or the precision of thermal expansion coefficient is within ±3×10⁻⁷/K, preferably within ±2×10⁻⁷/K.

A packaging carrier, made of the aforementioned glass material.

A glass element, made of the aforementioned glass material.

A device, comprising the aforementioned glass material.

The beneficial effects of the present invention are as follows: through rational component design, the glass material of the present invention has a suitable thermal expansion coefficient and is applicable to the field of semiconductor manufacturing.

### DETAILED DESCRIPTION

The implementations of the glass material of the present invention will be described in detail below, but the present invention is not limited to the following implementations. Appropriate changes may be made within the scope of the purpose of the present invention for implementation. In addition, the repeated descriptions will not limit the aim of the invention although with appropriate omissions. The glass material provided by the present invention is sometimes referred to as glass herein.

### [Glass Material]

In the following paragraphs, the range of components of the glass material provided by the present invention will be described. If not specified herein, the content of each component and the total content are expressed in weight percentage (wt %), that is, the content of each component, overall content and total content are expressed in weight percentage relative to the total glass materials converted into oxide composition. “Converted into oxide composition” therein refers to that the total weight of this oxide is taken as 100% when the oxide, compound salt and hydroxide, used as raw materials for the composition of glass material of the present invention, are decomposed and transformed into oxides during melting.

Unless otherwise noted in specific circumstances, the numerical range listed herein includes upper and lower limits, and the words “above” and “below” include the endpoint values as well as all integers and fractions within the range, but not limited to the specific values listed when the range is limited. “And/or” mentioned herein is inclusive. For example, “A and/or B” refers to only A, or only B, or both A and B.

### <Necessary Components and Optional Components>

SiO₂, a major component of glass framework, has a great impact on the high-temperature viscosity and chemical stability of the glass (especially water resistance). If the content of SiO₂ is less than 43%, the water resistance of the glass will be difficult to meet the design requirements. The high-temperature viscosity of the glass has an important influence on inherent quality and large size molding of the glass. The glass of the present invention system is usually clarified at a temperature above 1450° C., in order to obtain a better bubble degree. If the viscosity of the glass at 1450° C. is too large, the glass will be difficult to remove bubbles and the bubble degree of the product will be low.

On the other hand, in order to obtain a large-caliber glass blank, the glass usually needs to be molded under a suitable viscosity for smooth spreading and cooling, in order to obtain the large-caliber product with better stripe degree. If the content of SiO₂ is higher than 63%, the high-temperature viscosity of the glass will be difficult to meet the design requirements. Therefore, the content of SiO₂ is 43-63%, preferably is 46-60%, more preferably 49-56%.

B₂O₃ in the glass can further reinforce the glass network, enhance the chemical stability of the glass, and also adjust the thermal expansion coefficient of the glass. If the content of B₂O₃ exceeds 15%, B₂O₃ will be easy to volatilize under high temperature melting conditions. When the melting environment changes, the thermal expansion coefficient of the glass will change, resulting in that the precision of the expansion coefficient of the glass is difficult to meet the design requirements. Therefore, the content of B₂O₃ is 0-15%, preferably is 0.5-10%, more preferably 1-7%.

Al₂O₃ can increase the chemical stability of the glass, and decrease the thermal expansion coefficient of the glass, especially when the glass system contains more alkaline-earth metal oxides. If the content of Al₂O₃ is less than 2%, the above effect will not be obvious. If the content of Al₂O₃ exceeds 15%, melting of the glass will become very difficult, which is not conducive to improving the bubble degree and stripe degree of the glass. Therefore, the content of Al₂O₃ is 2-15%, preferably is 4-13%, more preferably 6-11%.

MgO, CaO, SrO and BaO, as alkaline-earth metal oxide, in the glass can reinforce the stability of the glass, decrease the high-temperature viscosity of the glass, and adjust the expansion coefficient and transition temperature of the glass. The present invention achieves the above effect by controlling the total content RO of MgO, CaO, SrO, and BaO within a range of 16-60%. RO is preferably 20-50%, RO is more preferably 25-45%, and RO is further preferably 28-40%.

Based on a large number of experimental researches, the inventor has found that the type, content and relative content of the alkaline-earth metal oxide exert a greater impact on the chemical stability, thermal expansion coefficient, transition temperature, and devitrification resistance of the glass.

MgO has the strongest ability to decrease the thermal expansion coefficient of the glass compared to other alkaline-earth metal components. Therefore, an appropriate amount of MgO can be contained in scenarios where the thermal expansion coefficient needs to be decreased. If the content of MgO exceeds 10%, the devitrification resistance of the glass will deteriorate rapidly. Therefore, the content of MgO is 0-10%, preferably is 0-5%, more preferably 0-2%. In some implementations, it further preferably contains no MgO.

CaO can significantly decrease the high-temperature viscosity of the glass. If the content of CaO exceeds 18%, the thermal expansion coefficient of the glass will be higher than the design requirements. Therefore, the content of CaO is 3-18%, preferably is 5-15%, more preferably 7-12%.

In some implementations, the ratio of the total content of Al₂O₃ and CaO (Al₂O₃+CaO) to the content of SiO₂, i.e., (Al₂O₃+CaO)/SiO₂, is controlled within a range of 0.1-0.65, which can make it easier for the glass to obtain the appropriate high-temperature viscosity and transition temperature, and optimize the precision of thermal expansion coefficient of the glass. Therefore, (Al₂O₃+CaO)/SiO₂ is preferably 0.1-0.65, and (Al₂O₃+CaO)/SiO₂ is more preferably 0.15-0.55. Furthermore, (Al₂O₃+CaO)/SiO₂ is controlled within a range of 0.2-0.5, which can also further optimize the bubble degree and chemical stability of the glass. Therefore, (Al₂O₃+CaO)/SiO₂ is further preferably 0.2-0.5, and (Al₂O₃+CaO)/SiO₂ is more further preferably 0.25-0.45.

BaO can decrease the high-temperature viscosity of the glass and adjust the transition temperature of the glass. If the content of BaO is less than 11%, the stability of the glass will decrease, and the high-temperature viscosity will be higher than the design requirements. If the content of BaO is higher than 30%, the thermal expansion coefficient of the glass will be higher than the design requirements, the chemical stability of the glass will deteriorate, and the density will increase. Therefore, the content of BaO is 11-30%, preferably is 15-25%, more preferably 17-23%.

In some implementations, the ratio of the content of BaO to the content of Al₂O₃, i.e., BaO/Al₂O₃, is controlled within a range of 1.0-10.0, which is beneficial for the glass to obtain the appropriate thermal expansion coefficient and high-temperature viscosity. Therefore, BaO/Al₂O₃ is preferably 1.0-10.0, and BaO/Al₂O₃ is more preferably 1.2-8.0. Furthermore, BaO/Al₂O₃ is controlled within a range of 1.5-5.0, which can also further increase the stripe degree and chemical stability of the glass. Therefore, BaO/Al₂O₃ is further preferably 1.5-5.0, and BaO/Al₂O₃ is more further preferably 1.8-3.0.

In some implementations, the ratio of the content of SiO₂ to the total content of BaO and CaO (BaO+CaO), i.e., SiO₂/(BaO+CaO) is controlled within a range of 1.0-4.0, which is beneficial for the glass to obtain the appropriate thermal expansion coefficient and meanwhile enhance the bubble degree of the glass. Therefore, SiO₂/(BaO+CaO) is preferably 1.0-4.0, and SiO₂/(BaO+CaO) is more preferably 1.2-3.0. Furthermore, SiO₂/(BaO+CaO) is controlled within a range of 1.3-2.5, which can also further optimize the Young's modulus and the precision of thermal expansion coefficient of the glass. Therefore, SiO₂/(BaO+CaO) is further preferably 1.3-2.5, and SiO₂/(BaO+CaO) is more further preferably 1.5-2.0.

In some implementations, the ratio of the total content of BaO and SrO (BaO+SrO) to the content of SiO₂, i.e., (BaO+SrO)/SiO₂ is controlled within a range of 0.2-0.8, which is conducive to increasing the Young's modulus of the glass and preventing the chemical stability of the glass from decreasing. Therefore, (BaO+SrO)/SiO₂ is preferably 0.2-0.8, and (BaO+SrO)/SiO₂ is more preferably 0.25-0.7. Furthermore, (BaO+SrO)/SiO₂ is controlled within a range of 0.3-0.65, which can also further optimize the bubble degree and devitrification resistance of the glass. Therefore, (BaO+SrO)/SiO₂ is further preferably 0.3-0.65, and (BaO+SrO)/SiO₂ is more further preferably 0.35-0.6.

In some implementations, the ratio of the total content of SiO₂ and Al₂O₃ (SiO₂+Al₂O₃) to the total content of BaO and B₂O₃(BaO+B₂O₃), i.e., (SiO₂+Al₂O₃)/(BaO+B₂O₃), is controlled within a range of 1.2-5.0, and the glass has appropriate thermal expansion coefficient as well as high Young's modulus. Therefore, (SiO₂+Al₂O₃)/(BaO+B₂O₃) is preferably 1.2-5.0, and (SiO₂+Al₂O₃)/(BaO+B₂O₃) is more preferably 1.5-4.0. Furthermore, (SiO₂+Al₂O₃)/(BaO+B₂O₃) is controlled within a range of 1.7-3.5, which can also further optimize the high-temperature viscosity and transition temperature of the glass, and optimize the precision of thermal expansion coefficient of the glass. Therefore, (SiO₂+Al₂O₃)/(BaO+B₂O₃) is further preferably 1.7-3.5, and (SiO₂+Al₂O₃)/(BaO+B₂O₃) is more further preferably 2.0-3.0.

SrO can adjust the high-temperature viscosity and transition temperature of the glass, and increase the Young's modulus of the glass. However, if the content of SrO is too high, and the devitrification resistance of the glass will be decreased. Therefore, the content of SrO is 0-12%, preferably is 0.5-10%, more preferably 1-7%.

In some implementations, the ratio of the content of SrO to the content of BaO, i.e., SrO/BaO, is controlled within a range of 0.02-0.8, which can enable the glass to obtain the appropriate transition temperature, and meanwhile prevent the devitrification resistance of the glass from decreasing. Therefore, SrO/BaO is preferably 0.02-0.8, and SrO/BaO is more preferably 0.05-0.6. Furthermore, SrO/BaO is controlled within a range of 0.1-0.5, which can also further optimize the chemical stability and thermal expansion coefficient of the glass. Therefore, SrO/BaO is further preferably 0.1-0.5, and SrO/BaO is more further preferably 0.1-0.4.

ZnO can enhance the chemical stability of the glass and decrease the thermal expansion coefficient of the glass. However, if the content of ZnO is higher than 8%, removal of bubbles in the process of high temperature clarification of the glass will become particularly difficult. Therefore, the content of ZnO is 0-8%, preferably is 0-5%, more preferably 0-2%. In some implementations, it further preferably contains no ZnO.

ZrO₂ can enhance the chemical stability of the glass. More importantly, the glass of the present invention system is melted at a relatively high temperature, and a small amount of ZrO₂ in the glass can obviously reduce the erosion of the glass liquid on the refractory material of the melting tank, significantly enhance the service life of the melting tank, and reduce the risk of non-melting material generation. If the content of ZrO₂ is higher than 8%, the glass is prone to non-melting materials, resulting in poor inherent quality of the glass. Therefore, the content of ZrO₂ is confined to be below 8%, preferably below 5%, more preferably below 2%.

An appropriate amount of P₂O₅ can increase the strength of the glass. However, if the content of P₂O₅ exceeds 5%, differential phase is easy to produce inside the glass, and the differential phase will scatter a portion of short wavelength, so that light transmittance fails to meet the design requirements. Therefore, the content of P₂O₅ is confined to 0-5%, preferably is 0-3%, more preferably 0-1%. In some implementations, it further preferably contains no P₂O₅.

TiO₂ can enhance the devitrification resistance and mechanical strength of the glass. If the content of TiO₂ exceeds 5%, the light transmittance of the glass will decrease rapidly to make subsequent laser stripping difficult, and meanwhile the thermal expansion coefficient of the glass will decrease, which fails to meet the design requirements. Therefore, the content of TiO₂ is below 5%, preferably below 3%, more preferably below 1%. In some implementations, it further preferably contains no TiO₂.

In some implementations, the ratio of the total content of ZnO and TiO₂ (ZnO+TiO₂) to the content of SrO, i.e., (ZnO+TiO₂)/SrO is controlled below 2.0, which can enable the glass to have appropriate transition temperature, and meanwhile prevent the devitrification resistance of the glass from decreasing. Therefore, (ZnO+TiO₂)/SrO is preferably below 2.0, and (ZnO+TiO₂)/SrO is more preferably below 1.5. Furthermore, (ZnO+TiO₂)/SrO is controlled below 1.0, which can also further optimize the stripe degree and chemical stability of the glass. Therefore, (ZnO+TiO₂)/SrO is further preferably below 1.0, and (ZnO+TiO₂)/SrO is more further preferably below 0.5.

Although alkali metal oxide Rn₂O (Rn₂O is one or more of Li₂O, Na₂O, and K₂O) can rapidly decrease the high-temperature viscosity of the glass, it will have a greater impact on the conductivity of the process liquid in the semiconductor manufacturing process after precipitation. Therefore, the content of Rn₂O is below 8%, preferably below 5%, more preferably below 1%, further preferably 0%.

In some implementations, the ratio of the alkali metal oxide Rn₂O to the content of BaO, i.e., Rn₂O/BaO, is controlled below 0.6, which can enable the glass to obtain appropriate high-temperature viscosity and thermal expansion coefficient, and meanwhile prevent the devitrification resistance of the glass from decreasing. Therefore, Rn₂O/BaO is preferably below 0.6, Rn₂O/BaO is more preferably below 0.5, Rn₂O/BaO is further preferably below 0.3, and Rn₂O/BaO is more further preferably below 0.1.

Ln₂O₃(Ln₂O₃ is one or more of La₂O₃, Gd₂O₃, Y₂O₃, and Yb₂O₃) can decrease the high-temperature viscosity of the glass. However, if the content of Ln₂O₃ is too high, the devitrification resistance of the glass will decrease rapidly. Therefore, the content of Ln₂O₃ is below 8%, preferably below 5%, more preferably below 2%, further preferably 0%.

In some implementations, the total content of Ln₂O₃ and CaO (Ln₂O₃+CaO) to the content of BaO, i.e., (Ln₂O₃+CaO)/BaO is controlled within a range of 0.15-1.5, and it is easier for the glass to obtain the desired high-temperature viscosity and increase the stripe degree of the glass. Therefore, (Ln₂O₃+CaO)/BaO is preferably 0.15-1.5, and (Ln₂O₃+CaO)/BaO is more preferably 0.2-1.0. Furthermore, (Ln₂O₃+CaO)/BaO is controlled within a range of 0.25-0.8, which can also further optimize the Young's modulus of the glass. Therefore, (Ln₂O₃+CaO)/BaO is further preferably 0.25-0.8, and (Ln₂O₃+CaO)/BaO is more further preferably 0.3-0.7.

By comprising one or more components of 0-2% of Sb₂O₃, SnO₂, and CeO₂ as clarifying agent in the present invention, it can increase the clarifying effect of the glass. The content of the clarifying agent is preferably 0-1%, more preferably 0-0.8%. In some implementations, Sb₂O₃ and/or SnO₂ is preferably used as the clarifying agent, and Sb₂O₃ is more preferably used as the clarifying agent.

### <Unnecessary Components>

Th, Cd, Ti, Os, Be and Se oxides have been used in a controlled manner as a harmful chemical substance in recent years, which is necessary not only in the glass manufacturing process, but also in the processing procedure and disposal after the productization for environmental protection measures. Therefore, in the case of attaching importance to the influence on the environment, it is preferably not actually included except for the inevitable incorporation. As a result, the glass does not actually contain a substance that contaminates the environment. Therefore, the glass of the present invention can be manufactured, processed, and discarded even if no measure is taken as a special environmental countermeasure.

In order to achieve environmental friendliness, As₂O₃ and PbO are not contained in the glass of the present invention. Although As₂O₃ can eliminate bubbles and better prevent glass from coloring, the addition of As₂O₃ will increase the platinum erosion of glass on the furnace, especially on the platinum furnace, resulting in more platinum ions entering the glass. It brings a negative impact on the service life of the platinum furnace. PbO can significantly improve the high refractive index and high dispersion performance of the glass, but both PbO and As₂O₃ cause environmental pollution.

The terms “not contained” and “0%” as used herein mean that the compound, molecule or element and the like are not intentionally added to the glass of the present invention as raw materials; however, as raw materials and/or equipment for the production of glass, there will be some impurities or components that are not intentionally added in small or trace amounts in the final glass, and this situation also falls within the protection scope of the present invention patent.

Hereinafter, the performance of the glass material provided by the present invention will be described.

### <Acid Resistance Stability>

The acid resistance stability (D_{A}) (powder method) of the glass is tested as per the method specified in GB/T 17129. The acid resistance stability herein is sometimes referred to as acid resistance or acid resistance stability.

In some implementations, the acid resistance stability (D_{A}) of the glass material provided by the present invention is above Class 2, preferably Class 1.

### <Water Resistance Stability>

The water resistance stability (D_{W}) (powder method) of the glass is tested as per the method specified in GB/T 17129. The water resistance stability herein is sometimes referred to as water resistance or water resistance stability.

In some implementations, the water resistance stability (D_{W}) of the glass material provided by the present invention is above Class 2, preferably Class 1.

### <Devitrification Resistance>

For large-scale and high-quality continuous glass production, the devitrification resistance of the glass is very important. If the devitrification resistance of the glass is poor, the glass is easy to produce devitrification at the three-phase interface in the hundreds or even thousands of hours of continuous molding process, resulting in that the inherent quality of the glass fails to meet the design requirements. In severe cases, molding device will be blocked, leading to the stop of the feeding, melting, clarifying and other processes in the front section, thereby seriously affecting the normal production.

The test method for devitrification resistance in the present invention is as follows: place 1,000 ml glass into a crucible, cool it to 1300° C. after the melting and clarification process, keep the temperature for 48 hours, pour it into a mould for molding, and use a microscope to observe the devitrification on the surface and inside of the glass after annealing and cooling.

In some implementations, the glass material of the present invention has no surface and inside devitrification after being kept at 1300° C. for 48 hours, and the devitrification resistance of the glass material is excellent.

### <Thermal Expansion Coefficient>

The thermal expansion coefficient mentioned in the present invention refers to the average expansion coefficient of the glass at 20-300° C., which is represented by α_{20-300° C.} and tested in accordance with the method specified in GB/T7962.16-2010.

In some implementations, the thermal expansion coefficient (α_{20-300° C.}) of the glass material provided by the present invention is 50×10⁻⁷/K-68×10⁻⁷/K, preferably 51×10⁻⁷/K-65×10⁻⁷/K, more preferably 52×10⁻⁷/K-64×10⁻⁷/K.

### <Precision of Thermal Expansion Coefficient>

The test method for the precision of thermal expansion coefficient is as follows: take a glass sample per hour in the glass manufacturing process, test thermal expansion coefficient (α_{20-300° C.}) of the glass sample in accordance with the method specified in GB/T7962.16-2010 after annealing based on −2° C./hour, and take the absolute value of the difference between the actual test value of thermal expansion coefficient of the glass sample and the theoretical thermal expansion coefficient of the glass (i.e., |actual test value of thermal expansion coefficient−theoretical thermal expansion coefficient of glass|). When the absolute value of the difference is the largest, the difference is the precision of thermal expansion coefficient. The smaller the value of |actual test value of thermal expansion coefficient−theoretical thermal expansion coefficient of glass|, the more favorable the application of glass in semiconductor manufacturing.

In some implementations, the precision of thermal expansion coefficient of the glass material provided by the present invention is within ±3×10⁻⁷/K, preferably within ±2×10⁻⁷/K.

### <Transition Temperature>

The Transition temperature (Tg) of the glass is tested according to the method specified in GB/T7962.16-2010.

If the transition temperature of the glass is low, the heat resistance of the glass will decrease, and softening deformation is easy to occur in the high temperature manufacturing process. If the transition temperature of the glass is too high, it will cause difficulties in the design of heat resistance of precision annealing equipment, resulting in a decrease in the reliability of precision annealing equipment. In particular, when the glass blank with a caliber greater than 450 mm is subject to precision annealing, the temperature needs to be kept under the transition temperature condition for a long time. If the transition temperature is too high, the reliability of the precision annealing equipment will be significantly decreased, thereby impacting the thermal expansion coefficient and the precision of thermal expansion coefficient.

In some implementations, the transition temperature (T_{g}) of the glass material provided by the present invention is above 620° C., preferably above 650° C., more preferably above 680° C.

In some implementations, the transition temperature (T_{g}) of the glass material provided by the present invention is below 760° C., preferably below 750° C., more preferably below 740° C.

### <Young's Modulus>

The Young's modulus (E) of the glass is calculated according to the following formula:

$$E = \frac{4 {G}^{2} - 3 {GV}_{T}^{2} ρ}{G - {V}_{T}^{2} ρ}$$

Where: G=Vₛ²ρ
where:
E refers to Young's modulus, Pa;
G refers to shear modulus, Pa;
V_{T} refers to P-wave velocity, m/s;
Vₛ refers to S-wave velocity, m/s;
ρ refers to glass density, g/cm³.

In some implementations, Young's modulus (E) of the glass material provided by the present invention is above 6500×10⁷ Pa, preferably above 7000×10⁷ Pa, more preferably above 7500×10⁷ Pa.

### <Bubble Degree>

The bubble degree of the glass is tested as per the method specified in GB/T7962.8-2010.

In some implementations, the bubble degree of the glass material provided by the present invention is above Grade A, preferably above Grade A₀, more preferably Grade A₀₀.

### <Stripe Degree>

The stripe degree of the glass is compared with the standard sample, by a stripe instrument composed of a point light source and a lens, from the direction where the stripe is most easily seen. The stripe degree is divided into four levels as shown in Table 1 below.

TABLE 1
Rating Scale of Stripe Degree

| Grade | Stripe degree |
|---|---|
| A | Without visible stripe under |
| | specified testing conditions. |
| B | With small and scattered stripes |
| | under specified testing conditions. |
| C | With slightly parallel stripes |
| | under specified testing conditions. |
| D | With roughly parallel stripes |
| | under specified testing conditions. |

In some implementations, the stripe degree of the glass material provided by the present invention is above Grade C, preferably above Grade B.

### <Viscosity>

The viscosity of the glass is tested according to the following method: use THETA Rheotronic II high temperature viscometer for test with rotation method, taking dPaS (Poise) as the unit of value. The smaller the value is, the smaller the viscosity is.

In some implementations, the viscosity of the glass material provided by the present invention at 1450° C. is below 250 dPaS, the viscosity at 1450° C. is preferably below 220 dPaS, and the viscosity at 1450° C. is more preferably below 200 dPaS.

In some implementations, the viscosity of the glass material provided by the present invention at 1300° C. is above 400 dPaS, the viscosity at 1300° C. is preferably above 500 dPaS, and the viscosity at 1300° C. is more preferably above 600 dPaS.

Due to the above excellent performance, the glass material of the present invention can be used to manufacture a packaging carrier (substrate material) for the semiconductor manufacturing process.

The glass material of the present invention can be used to manufacture various glass elements, and can provide various glass elements such as lens and prism with high optical value. Examples of the lens include various lenses with spherical or aspheric surfaces, such as concave meniscus lens, convex meniscus lens, biconvex lens, biconcave lens, planoconvex lens and planoconcave lens.

The glass material of the present invention can also be used to manufacture various devices (the device of the present invention includes instrument, equipment, etc.), such as imaging device, sensor, microscope, medical technology, digital projection, communication, optical communication technology/information transmission, optics/lighting in the automobile field, photoetching technology, excimer laser, wafer, computer chip, and integrated circuit and electronic device comprising such circuit and chip, or camera equipment and device used in the fields of on-board product, surveillance and security.

### [Manufacturing Method]

The manufacturing method of the glass material provided by the present invention is as follows: use carbonate, nitrate, sulfate, hydroxide, oxide, phosphate, and metaphosphate as raw materials, mix the ingredients according to the conventional method, and then feed the mixed furnace burden into a 1300-1500° C. smelting furnace for melting. Later, obtain homogeneous molten glass without bubbles and undissolved substances after clarification, stirring and homogenization, shape the molten glass in a mould and perform annealing. Those skilled in the art can appropriately select raw materials, process methods and process parameters according to actual needs.

### EMBODIMENT

The following non-limiting embodiments 1 #-24 #are provided in order to further clearly explain and illustrate the technical solution of the present invention. The embodiment obtains the glass material with the composition shown in Tables 2 to 4 by the above manufacturing method of the glass material. In addition, the characteristics of each glass are measured by the test method described in the present invention, and the measurement results are shown in Tables 2 to 4.

TABLE 2

| Embodiment (wt %) | 1# | 2# | 3# | 4# | 5# | 6# | 7# | 8# |
|---|---|---|---|---|---|---|---|---|
| SiO₂ | 44.5 | 47.3 | 61.5 | 49.3 | 57.2 | 45.5 | 60 | 53.9 |
| B₂O₃ | 12.3 | 1.2 | 0 | 10.6 | 1.6 | 6.4 | 3.5 | 2.2 |
| BaO | 14.4 | 24.6 | 15.9 | 17.4 | 13.4 | 15.1 | 11.5 | 16.4 |
| SrO | 11.5 | 1.6 | 4.5 | 9.2 | 3.2 | 2.2 | 6.6 | 5.5 |
| CaO | 3.6 | 16.5 | 5.2 | 6.5 | 4.4 | 14.3 | 7.1 | 8.3 |
| Al₂O₃ | 10.4 | 3.2 | 6.6 | 5.7 | 12.1 | 13.5 | 4.3 | 11.4 |
| ZrO₂ | 0.2 | 1 | 0 | 0.5 | 3 | 0.3 | 2.2 | 1.3 |
| MgO | 1 | 0 | 1.3 | 0 | 0 | 2 | 0 | 0 |
| Li₂O | 0 | 0 | 0 | 0 | 1.5 | 0 | 0.4 | 0 |
| Na₂O | 0 | 0 | 2 | 0 | 0 | 0 | 1.5 | 0 |
| K₂O | 0 | 1 | 0 | 0 | 0 | 0 | 1.5 | 0 |
| La₂O₃ | 0 | 0 | 0 | 0 | 1 | 0 | 0 | 0 |
| Gd₂O₃ | 0 | 0 | 0 | 0 | 0 | 0 | 0 | 0.8 |
| Y₂O₃ | 0 | 0 | 0 | 0.5 | 0 | 0 | 0 | 0 |
| Yb₂O₃ | 0 | 0 | 0 | 0 | 0 | 0 | 0 | 0 |
| ZnO | 0 | 1.5 | 3 | 0 | 2 | 0 | 1 | 0 |
| TiO₂ | 2 | 1 | 0 | 0 | 0.4 | 0 | 0 | 0 |
| P₂O₅ | 0 | 1 | 0 | 0 | 0 | 0.5 | 0 | 0 |
| Sb₂O₃ | 0.1 | 0.1 | 0 | 0.3 | 0.2 | 0.1 | 0.4 | 0.2 |
| CeO₂ | 0 | 0 | 0 | 0 | 0 | 0.1 | 0 | 0 |
| SnO₂ | 0 | 0 | 0 | 0 | 0 | 0 | 0 | 0 |
| Total | 100 | 100 | 100 | 100 | 100 | 100 | 100 | 100 |
| RO | 30.5 | 42.7 | 26.9 | 33.1 | 21 | 33.6 | 25.2 | 30.2 |
| (Al₂O₃ + CaO)/SiO₂ | 0.315 | 0.416 | 0.192 | 0.247 | 0.288 | 0.611 | 0.19 | 0.365 |
| SiO₂/(BaO + CaO) | 2.472 | 1.151 | 2.915 | 2.063 | 3.213 | 1.548 | 3.226 | 2.182 |
| (BaO + SrO)/SiO₂ | 0.582 | 0.554 | 0.332 | 0.54 | 0.29 | 0.38 | 0.302 | 0.406 |
| BaO/Al₂O₃ | 1.385 | 7.688 | 2.409 | 3.053 | 1.107 | 1.119 | 2.674 | 1.439 |
| Rn₂O/BaO | 0 | 0.041 | 0.126 | 0 | 0.112 | 0 | 0.296 | 0 |
| (Ln₂O₃ + CaO)/BaO | 0.25 | 0.671 | 0.327 | 0.402 | 0.403 | 0.947 | 0.617 | 0.555 |
| SrO/BaO | 0.799 | 0.065 | 0.283 | 0.529 | 0.239 | 0.146 | 0.574 | 0.335 |
| (ZnO + TiO₂)/SrO | 0.174 | 1.563 | 0.667 | 0 | 0.75 | 0 | 0.152 | 0 |
| (SiO₂ + Al₂O₃)/(BaO + B₂O₃) | 2.056 | 1.957 | 4.283 | 1.964 | 4.62 | 2.744 | 4.287 | 3.511 |
| α_{20-300° C.}(×10⁻⁷/K) | 53 | 51 | 52 | 54 | 66 | 55 | 67 | 65 |
| Precision of thermal | −1 | −2 | +2 | +1 | +2 | −2 | −3 | +2 |
| expansion coefficient | | | | | | | | |
| (×10⁻⁷/K) | | | | | | | | |
| T_{g}(° C.) | 722 | 680 | 730 | 715 | 720 | 717 | 728 | 720 |
| D_{w} | Class 1 | Class 1 | Class 1 | Class 1 | Class 1 | Class 1 | Class 1 | Class 1 |
| D_{A} | Class 1 | Class 1 | Class 1 | Class 1 | Class 1 | Class 1 | Class 1 | Class 1 |
| E(×10⁷ Pa) | 7692 | 7683 | 7473 | 7657 | 7486 | 7502 | 7433 | 7527 |
| Bubble degree (level) | A₀₀ | A₀ | A | A₀₀ | A | A₀ | A | A₀₀ |
| Stripe degree (Grade) | C | C | C | B | C | C | B | C |
| Viscosity at 1450° C. | 205 | 202 | 210 | 195 | 207 | 221 | 214 | 201 |
| (dPaS) | | | | | | | | |
| Viscosity at 1300° C. | 612 | 624 | 630 | 655 | 606 | 575 | 593 | 643 |
| (dPaS) | | | | | | | | |

TABLE 3

| Embodiment (wt %) | 9# | 10# | 11# | 12# | 13# | 14# | 15# | 16# |
|---|---|---|---|---|---|---|---|---|
| SiO₂ | 48.7 | 50.8 | 48.3 | 47.9 | 51.2 | 47.3 | 48.9 | 49.7 |
| B₂O₃ | 5.3 | 2.4 | 7.4 | 1.6 | 0.3 | 2.7 | 4.2 | 1.4 |
| BaO | 18.3 | 20 | 19.5 | 22.1 | 23.4 | 28.6 | 21.4 | 25.3 |
| SrO | 2 | 0.7 | 4.3 | 8.4 | 7.2 | 4.2 | 10.2 | 3.3 |
| CaO | 13.1 | 15.2 | 10.3 | 9.5 | 8.3 | 8.6 | 7.4 | 11.4 |
| Al₂O₃ | 7.2 | 8.4 | 8.2 | 9.3 | 9.1 | 8.3 | 7.7 | 8.5 |
| ZrO₂ | 3.6 | 0.3 | 0.5 | 0.2 | 0 | 0.1 | 0.1 | 0.2 |
| MgO | 0.4 | 0 | 0 | 0.7 | 0 | 0 | 0 | 0 |
| Li₂O | 0 | 0 | 0 | 0 | 0 | 0 | 0 | 0 |
| Na₂O | 0.7 | 0 | 0 | 0 | 0 | 0 | 0 | 0 |
| K₂O | 0 | 0 | 0 | 0 | 0 | 0 | 0 | 0 |
| La₂O₃ | 0 | 0 | 0 | 0 | 0 | 0 | 0 | 0 |
| Gd₂O₃ | 0 | 0 | 1 | 0 | 0 | 0 | 0 | 0 |
| Y₂O₃ | 0 | 2 | 0 | 0 | 0 | 0 | 0 | 0 |
| Yb₂O₃ | 0 | 0 | 0 | 0 | 0 | 0 | 0 | 0 |
| ZnO | 0.5 | 0 | 0.2 | 0 | 0 | 0 | 0 | 0 |
| TiO₂ | 0 | 0 | 0 | 0 | 0 | 0 | 0 | 0 |
| P₂O₅ | 0 | 0 | 0 | 0 | 0 | 0 | 0 | 0 |
| Sb₂O₃ | 0.1 | 0 | 0.3 | 0.3 | 0.5 | 0.2 | 0.1 | 0.2 |
| CeO₂ | 0 | 0 | 0 | 0 | 0 | 0 | 0 | 0 |
| SnO₂ | 0.1 | 0.2 | 0 | 0 | 0 | 0 | 0 | 0 |
| Total | 100 | 100 | 100 | 100 | 100 | 100 | 100 | 100 |
| RO | 33.8 | 35.9 | 34.1 | 40.7 | 38.9 | 41.4 | 39 | 40 |
| (Al₂O₃ + CaO)/SiO₂ | 0.417 | 0.465 | 0.383 | 0.392 | 0.34 | 0.357 | 0.309 | 0.4 |
| SiO₂/(BaO + CaO) | 1.551 | 1.443 | 1.621 | 1.516 | 1.615 | 1.272 | 1.698 | 1.354 |
| (BaO + SrO)/SiO₂ | 0.417 | 0.407 | 0.493 | 0.637 | 0.598 | 0.693 | 0.646 | 0.575 |
| BaO/Al₂O₃ | 2.542 | 2.381 | 2.378 | 2.376 | 2.571 | 3.446 | 2.779 | 2.976 |
| Rn₂O/BaO | 0.038 | 0 | 0 | 0 | 0 | 0 | 0 | 0 |
| (Ln₂O₃ + CaO)/BaO | 0.716 | 0.86 | 0.579 | 0.43 | 0.355 | 0.301 | 0.346 | 0.451 |
| SrO/BaO | 0.109 | 0.035 | 0.221 | 0.38 | 0.308 | 0.147 | 0.477 | 0.13 |
| (ZnO + TiO₂)/SrO | 0.25 | 0 | 0.047 | 0 | 0 | 0 | 0 | 0 |
| (SiO₂ + Al₂O₃)/(BaO + B₂O₃) | 2.369 | 2.643 | 2.1 | 2.414 | 2.544 | 1.776 | 2.211 | 2.18 |
| α_{20-300° C.}(×10⁻⁷/K) | 56 | 64 | 63 | 58 | 56 | 55 | 57 | 61 |
| Precision of thermal | −1 | −1 | +1 | 0 | 0 | −1 | −1 | +1 |
| expansion coefficient | | | | | | | | |
| (×10⁻⁷/K) | | | | | | | | |
| T_{g}(° C.) | 697 | 675 | 692 | 702 | 708 | 698 | 704 | 710 |
| D_{w} | Class 1 | Class 1 | Class 1 | Class 1 | Class 1 | Class 1 | Class 1 | Class 1 |
| D_{A} | Class 1 | Class 1 | Class 1 | Class 1 | Class 1 | Class 1 | Class 1 | Class 1 |
| E(×10⁷Pa) | 7638 | 7625 | 7752 | 7710 | 7737 | 7724 | 7715 | 7823 |
| Bubble degree (level) | A₀₀ | A₀₀ | A₀₀ | A₀ | A₀₀ | A₀ | A₀ | A₀₀ |
| Stripe degree (Grade) | C | C | B | B | B | B | B | B |
| Viscosity at 1450° C. | 210 | 207 | 175 | 183 | 167 | 185 | 154 | 166 |
| (dPaS) | | | | | | | | |
| Viscosity at 1300° C. | 630 | 646 | 673 | 660 | 676 | 658 | 670 | 650 |
| (dPaS) | | | | | | | | |

TABLE 4

| Embodiment (wt %) | 17# | 18# | 19# | 20# | 21# | 22# | 23# | 24# |
|---|---|---|---|---|---|---|---|---|
| SiO₂ | 52.8 | 53 | 56 | 49 | 51 | 52.7 | 51.7 | 49.8 |
| B₂O₃ | 4.6 | 4.2 | 0.5 | 5.3 | 8.2 | 5.5 | 2.3 | 3.5 |
| BaO | 18.5 | 19.2 | 20.3 | 22.6 | 18.5 | 19.2 | 20.7 | 21.4 |
| SrO | 4.1 | 3.5 | 2.4 | 2.2 | 4.6 | 5.1 | 5.2 | 4.3 |
| CaO | 10.8 | 12.5 | 10.6 | 9.7 | 8.5 | 7.6 | 9.6 | 13.5 |
| Al₂O₃ | 8.6 | 7.3 | 9.5 | 10.2 | 8.8 | 9.1 | 10 | 6.8 |
| ZrO₂ | 0.4 | 0.2 | 0.6 | 0.8 | 0.3 | 0.4 | 0.2 | 0.5 |
| MgO | 0 | 0 | 0 | 0 | 0 | 0 | 0 | 0 |
| Li₂O | 0 | 0 | 0 | 0 | 0 | 0 | 0 | 0 |
| Na₂O | 0 | 0 | 0 | 0 | 0 | 0 | 0 | 0 |
| K₂O | 0 | 0 | 0 | 0 | 0 | 0 | 0 | 0 |
| La₂O₃ | 0 | 0 | 0 | 0 | 0 | 0 | 0 | 0 |
| Gd₂O₃ | 0 | 0 | 0 | 0 | 0 | 0 | 0 | 0 |
| Y₂O₃ | 0 | 0 | 0 | 0 | 0 | 0 | 0 | 0 |
| Yb₂O₃ | 0 | 0 | 0 | 0 | 0 | 0 | 0 | 0 |
| ZnO | 0 | 0 | 0 | 0 | 0 | 0 | 0 | 0 |
| TiO₂ | 0 | 0 | 0 | 0 | 0 | 0 | 0 | 0 |
| P₂O₅ | 0 | 0 | 0 | 0 | 0 | 0 | 0 | 0 |
| Sb₂O₃ | 0.2 | 0 | 0 | 0.2 | 0.1 | 0.4 | 0.3 | 0.2 |
| CeO₂ | 0 | 0 | 0 | 0 | 0 | 0 | 0 | 0 |
| SnO₂ | 0 | 0.1 | 0.1 | 0 | 0 | 0 | 0 | 0 |
| Total | 100 | 100 | 100 | 100 | 100 | 100 | 100 | 100 |
| RO | 33.4 | 35.2 | 33.3 | 34.5 | 31.6 | 31.9 | 35.5 | 39.2 |
| (Al₂O₃ + CaO)/SiO₂ | 0.367 | 0.374 | 0.359 | 0.406 | 0.339 | 0.317 | 0.379 | 0.408 |
| SiO₂/(BaO + CaO) | 1.802 | 1.672 | 1.812 | 1.517 | 1.889 | 1.966 | 1.706 | 1.427 |
| (BaO + SrO)/SiO₂ | 0.428 | 0.428 | 0.405 | 0.506 | 0.453 | 0.461 | 0.501 | 0.516 |
| BaO/Al₂O₃ | 2.151 | 2.63 | 2.137 | 2.216 | 2.102 | 2.11 | 2.07 | 3.147 |
| Rn₂O/BaO | 0 | 0 | 0 | 0 | 0 | 0 | 0 | 0 |
| (Ln₂O₃ + CaO)/BaO | 0.584 | 0.651 | 0.522 | 0.429 | 0.459 | 0.396 | 0.464 | 0.631 |
| SrO/BaO | 0.222 | 0.182 | 0.118 | 0.097 | 0.249 | 0.266 | 0.251 | 0.201 |
| (ZnO + TiO₂)/SrO | 0 | 0 | 0 | 0 | 0 | 0 | 0 | 0 |
| (SiO₂ + Al₂O₃)/(BaO + B₂O₃) | 2.658 | 2.577 | 3.149 | 2.122 | 2.24 | 2.502 | 2.683 | 2.273 |
| α_{20-300° C.}(×10⁻⁷/K) | 59 | 60 | 58 | 55 | 56 | 58 | 58 | 57 |
| Precision of thermal | +1 | +1 | 0 | −1 | −1 | +1 | +1 | −1 |
| expansion coefficient | | | | | | | | |
| (×10⁻⁷/K) | | | | | | | | |
| T_{g}(° C.) | 690 | 705 | 701 | 696 | 698 | 695 | 703 | 700 |
| D_{w} | Class 1 | Class 1 | Class 1 | Class 1 | Class 1 | Class 1 | Class 1 | Class 1 |
| D_{A} | Class 1 | Class 1 | Class 1 | Class 1 | Class 1 | Class 1 | Class 1 | Class 1 |
| E(×10⁷Pa) | 7748 | 7785 | 7813 | 7744 | 7808 | 7756 | 7810 | 7745 |
| Bubble degree (level) | A₀₀ | A₀₀ | A₀₀ | A₀₀ | A₀₀ | A₀₀ | A₀₀ | A₀₀ |
| Stripe degree (Grade) | B | B | B | B | B | B | B | B |
| Viscosity at 1450° C. | 174 | 192 | 184 | 185 | 170 | 169 | 180 | 188 |
| (dPaS) | | | | | | | | |
| Viscosity at 1300° C. | 663 | 657 | 690 | 686 | 695 | 680 | 677 | 684 |
| (dPaS) | | | | | | | | |

1. A glass material, wherein components thereof are represented by weight percentage, comprising: 43-63% of SiO₂; 0-15% of B₂O₃; 2-15% of Al₂O₃; 11-30% of BaO; 3-18% of CaO.

2. The glass material according to claim 1, wherein components thereof are represented by weight percentage, further comprising: 0-12% of SrO; and/or 0-8% of ZrO₂; and/or 0-10% of MgO; and/or 0-8% of Rn₂O; and/or 0-8% of Ln₂O₃; and/or 0-8% of ZnO; and/or 0-5% of TiO₂; and/or 0-5% of P₂O₅; and/or 0-2% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, SnO₂, and CeO₂.

3. The glass material according to claim 1, wherein components thereof are represented by weight percentage, comprising: 46-60% of SiO₂; and/or 0.5-10% of B₂O₃; and/or 4-13% of Al₂O₃; and/or 15-25% of BaO; and/or 5-15% of CaO; and/or 0.5-10% of SrO; and/or 0-5% of ZrO₂; and/or 0-5% of MgO; and/or 0-5% of Rn₂O; and/or 0-5% of Ln₂O₃; and/or 0-5% of ZnO; and/or 0-3% of TiO₂; and/or 0-3% of P₂O₅; and/or 0-1% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, SnO₂, and CeO₂.

4. The glass material according to claim 1, wherein components thereof are represented by weight percentage, comprising: 49-56% of SiO₂; and/or 1-7% of B₂O₃; and/or 6-11% of Al₂O₃; and/or 17-23% of BaO; and/or 7-12% of CaO; and/or 1-7% of SrO; and/or 0-2% of ZrO₂; and/or 0-2% of MgO; and/or 0-1% of Rn₂O; and/or 0-2% of Ln₂O₃; and/or 0-2% of ZnO; and/or 0-1% of TiO₂; and/or 0-1% of P₂O₅; and/or 0-0.8% of clarifying agent; the Rn₂O is one or more of Li₂O, Na₂O, and K₂O, Ln₂O₃ is one or more of La₂O₃, Gd₂O₃, Y₂O₃, and Yb₂O₃, and the clarifying agent is one or more of Sb₂O₃, SnO₂, and CeO₂.

5. The glass material according to claim 1, wherein components thereof are represented by weight percentage, and one or more of the following 10 conditions are satisfied:
1) RO is 16-60%;
2) (Al₂O₃+CaO)/SiO₂ is 0.1-0.65;
3) SiO₂/(BaO+CaO) is 1.0-4.0;
4) (BaO+SrO)/SiO₂ is 0.2-0.8;
5) BaO/Al₂O₃ is 1.0-10.0;
6) Rn₂O/BaO is below 0.6;
7) (Ln₂O₃+CaO)/BaO is 0.15-1.5;
8) SrO/BaO is 0.02-0.8;
9) (ZnO+TiO₂)/SrO is below 2.0;
10) (SiO₂+Al₂O₃)/(BaO+B₂O₃) is 1.2-5.0, the RO is a total content of MgO, CaO, SrO, and BaO, the Rn₂O is one or more of Li₂O, Na₂O, and K₂O, and the Ln₂O₃ is one or more of La₂O₃, Gd₂O₃, Y₂O₃, and Yb₂O₃.

6. The glass material according to claim 1, wherein components thereof are represented by weight percentage, and one or more of the following 10 conditions are satisfied:
1) RO is 20-50%;
2) (Al₂O₃+CaO)/SiO₂ is 0.15-0.55;
3) SiO₂/(BaO+CaO) is 1.2-3.0;
4) (BaO+SrO)/SiO₂ is 0.25-0.7;
5) BaO/Al₂O₃ is 1.2-8.0;
6) Rn₂O/BaO is below 0.5;
7) (Ln₂O₃+CaO)/BaO is 0.2-1.0;
8) SrO/BaO is 0.05-0.6;
9) (ZnO+TiO₂)/SrO is below 1.5;
10) (SiO₂+Al₂O₃)/(BaO+B₂O₃) is 1.5-4.0, the RO is the total content of MgO, CaO, SrO, and BaO, the Rn₂O is one or more of Li₂O, Na₂O, and K₂O, and the Ln₂O₃ is one or more of La₂O₃, Gd₂O₃, Y₂O₃, and Yb₂O₃.

7. The glass material according to claim 1, wherein components thereof are represented by weight percentage, and one or more of the following 10 conditions are satisfied:
1) RO is 25-45%;
2) (Al₂O₃+CaO)/SiO₂ is 0.2-0.5;
3) SiO₂/(BaO+CaO) is 1.3-2.5;
4) (BaO+SrO)/SiO₂ is 0.3-0.65;
5) BaO/Al₂O₃ is 1.5-5.0;
6) Rn₂O/BaO is below 0.3;
7) (Ln₂O₃+CaO)/BaO is 0.25-0.8;
8) SrO/BaO is 0.1-0.5;
9) (ZnO+TiO₂)/SrO is below 1.0;
10) (SiO₂+Al₂O₃)/(BaO+B₂O₃) is 1.7-3.5, the RO is the total content of MgO, CaO, SrO, and BaO, the Rn₂O is one or more of Li₂O, Na₂O, and K₂O, and the Ln₂O₃ is one or more of La₂O₃, Gd₂O₃, Y₂O₃, and Yb₂O₃.

8. The glass material according to claim 1, wherein components thereof are represented by weight percentage, and one or more of the following 10 conditions are satisfied:
1) RO is 28-40%;
2) (Al₂O₃+CaO)/SiO₂ is 0.25-0.45;
3) SiO₂/(BaO+CaO) is 1.5-2.0;
4) (BaO+SrO)/SiO₂ is 0.35-0.6;
5) BaO/Al₂O₃ is 1.8-3.0;
6) Rn₂O/BaO is below 0.1;
7) (Ln₂O₃+CaO)/BaO is 0.3-0.7;
8) SrO/BaO is 0.1-0.4;
9) (ZnO+TiO₂)/SrO is below 0.5;
10) (SiO₂+Al₂O₃)/(BaO+B₂O₃) is 2.0-3.0, the RO is the total content of MgO, CaO, SrO, and BaO, the Rn₂O is one or more of Li₂O, Na₂O, and K₂O, and the Ln₂O₃ is one or more of La₂O₃, Gd₂O₃, Y₂O₃, and Yb₂O₃.

9. The glass material according to claim 1, wherein components thereof do not contain MgO; and/or do not contain ZnO; and/or do not contain P₂O₅; and/or do not contain TiO₂; and/or do not contain Rn₂O; and/or do not contain Ln₂O₃, the Rn₂O is one or more of Li₂O, Na₂O, and K₂O, and Ln₂O₃ is one or more of La₂O₃, Gd₂O₃, Y₂O₃, and Yb₂O₃.

10. The glass material according to claim 1, wherein thermal expansion coefficient α_{20-300° C.} of the glass material is 50×10⁻⁷/K-68×10⁻⁷/K; and/or transition temperature T_{g} is 620° C.-760° C.; and/or Young's modulus E is above 6500×10⁷ Pa; and/or acid resistance stability D_{A} is above Class 2; and/or water resistance stability D_{W} is above Class 2; and/or bubble degree is above Grade A; and/or stripe degree is above Grade C; and/or viscosity at 1450° C. is below 250 dPaS; and/or viscosity at 1300° C. is above 400 dPaS; and/or precision of thermal expansion coefficient is within ±3×10⁻⁷/K.

11. The glass material according to claim 1, wherein thermal expansion coefficient α_{20-300° C.} of the glass material is 52×10⁻⁷/K-64×10⁻⁷/K; and/or transition temperature T_{g} is 680° C.-740° C.; and/or Young's modulus E is above 7500×10⁷ Pa; and/or acid resistance stability D_{A} is Class 1; and/or water resistance stability D_{W} is Class 1; and/or bubble degree is Grade A₀₀; and/or stripe degree is above Grade B; and/or viscosity at 1450° C. is below 200 dPaS; and/or viscosity at 1300° C. is above 600 dPaS; and/or precision of thermal expansion coefficient is within ±2×10⁻⁷/K.

12. A packaging carrier, made of the glass material according to claim 1.

13. A glass element, made of the glass material according to claim 1.

14. A device, comprising the glass material according to claim 1.
